(19) United States
(12) Patent Application Publication
(10) Pub. No.: US 2025/0196721 A1
(43) Pub. Date: Jun. 19, 2025

(54) WORK VEHICLE

(71) Applicant: KOMATSU LTD., Tokyo (JP)

(72) Inventors: Takuya SATO, Tokyo (JP); Takashi HIROTA, Tokyo (JP); Koji OBATA, Tokyo (JP)

(21) Appl. No.: 18/846,694

(22) PCT Filed: Mar. 17, 2023
(86) PCT No.: PCT/JP2023/010612

§ 371 Date: Sep. 13, 2024

(30) Foreign Application Priority Data
Mar. 17, 2022 (JP) 2022-042150

(51) Int. Cl. B60L 58/31; B60L 50/70; H02M 1/14; H02M 3/158; H02M 3/335

(52) U.S. Cl. CPC B60L 58/31; B60L 50/70; H02M 1/14; H02M 3/158; H02M 3/33573; B60L 2200/40; B60L 2210/12; B60L 2210/40

(57) ABSTRACT

A work vehicle includes a step-down circuit provided between a fuel cell and a converter, a contactor provided in parallel with the step-down circuit and configured to switch conduction and insulation between the fuel cell and the converter and a control device configured to control the step-down circuit and the contactor.

### TECHNICAL FIELD

The present disclosure relates to a work vehicle.

Priority is claimed on Japanese Patent Application No. 2022-042150, filed Mar. 17, 2022, the content of which is incorporated herein by reference.

### BACKGROUND ART

Patent Document 1 discloses a configuration of a power module of a work vehicle equipped with a fuel cell.

### CITATION LIST

### Patent Document

Patent Document 1: PCT International Publication No. WO2021/064010

### SUMMARY OF INVENTION

### Technical Problem

It is known that the fuel cell outputs a voltage significantly higher than the rated output voltage during startup. Therefore, it is necessary to set the withstand voltage of an element constituting a device, such as a converter, connected to the fuel cell to be equal to or higher than the voltage during startup.

An object of the present disclosure is to provide a work vehicle capable of suppressing voltage fluctuations during the startup of a fuel cell.

### Solution to Problem

According to an aspect of the present disclosure, a work vehicle includes: a travel device; an electric motor configured to drive the travel device; a fuel cell that is a power source of the electric motor; a converter connected to the electric motor; a chopper circuit provided between the fuel cell and the converter; a contactor provided in parallel with the chopper circuit and configured to switch conduction and insulation between the fuel cell and the converter; and a control device configured to control the chopper circuit and the contactor.

### Advantageous Effects of Invention

According to the above aspect, it is possible to suppress the voltage fluctuations during the startup of the fuel cell.

### BRIEF DESCRIPTION OF DRAWINGS

FIG. 1 A perspective view schematically showing a transport vehicle according to a first embodiment.

FIG. 2 A schematic diagram showing the configuration of a power control system according to the first embodiment.

FIG. 3 A circuit diagram showing the configuration of a chopper circuit according to the first embodiment.

FIG. 4 A circuit diagram showing the configuration of a converter according to the first embodiment.

FIG. 5 A flowchart showing a startup control of a fuel cell according to the first embodiment.

FIG. 6 A circuit diagram showing the configuration of a step-down circuit according to a second embodiment.

### DESCRIPTION OF EMBODIMENTS

### First Embodiment

### <<Configuration of Transport Vehicle 10>>

Hereinafter, embodiments will be described in detail with reference to the drawings.

A transport vehicle 10 according to a first embodiment is a rigid frame-type dump truck that transports a crushed stone material or the like mined in a mine. The transport vehicle 10 is driven by a fuel cell that uses hydrogen gas as a fuel. The transport vehicle 10 is an example of a work vehicle.

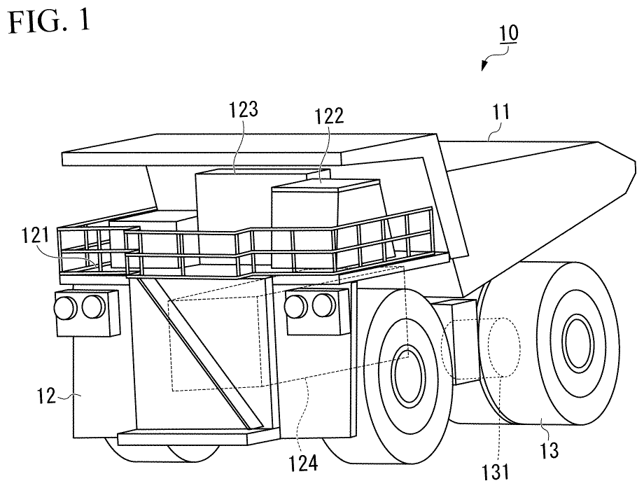

FIG. 1 is a perspective view schematically showing the transport vehicle 10 according to the first embodiment. The transport vehicle 10 includes a dump body 11, a vehicle body 12, and a travel device 13.

The dump body 11 is a member into which a cargo is loaded. At least a part of the dump body 11 is disposed above the vehicle body 12.

The vehicle body 12 includes a vehicle body frame (not shown). The vehicle body 12 rotatably supports the dump body 11 through a hinge pin provided on the vehicle body frame. The vehicle body 12 is supported by the travel device 13. A platform 121 is provided at the vehicle body frame above front wheels of the travel device 13. The platform 121 is a flat plate configuring an upper surface of the vehicle body frame. A cab 122 and a control cabinet 123 are provided on the upper surface of the platform 121. In addition, a plurality of fuel cells 124 are provided on the vehicle body frame. The fuel cell 124 generates electric power by reacting hydrogen gas with oxygen in the air. The fuel cell 124 outputs a voltage equal to or lower than the rated voltage (for example, 800 V) during normal operation (steady operation). On the other hand, the fuel cell 124 may output a transient voltage (for example, 1200 V) exceeding the rated voltage at startup from a stop state.

The control cabinet 123 converts electric power. Specifically, the control cabinet 123 houses a power control system 20 that performs power control between the fuel cells 124 and various electric devices (such as a battery, a travel motor, and a hydraulic pump motor).

The travel device 13 supports the vehicle body 12. The travel device 13 causes the transport vehicle 10 to travel. The travel device 13 causes the transport vehicle 10 to advance or retreat. At least a part of the travel device 13 is disposed below the vehicle body 12. The travel device 13 includes a pair of front wheels and a pair of rear wheels. The front wheels are steering wheels, and the rear wheels are driving wheels. The travel device 13 includes an electric motor 131. The electric motor 131 drives the travel device 13 with electric power supplied to the bus of the power control system 20, which will be described below.

### <<Configuration of Power Control System 20>>

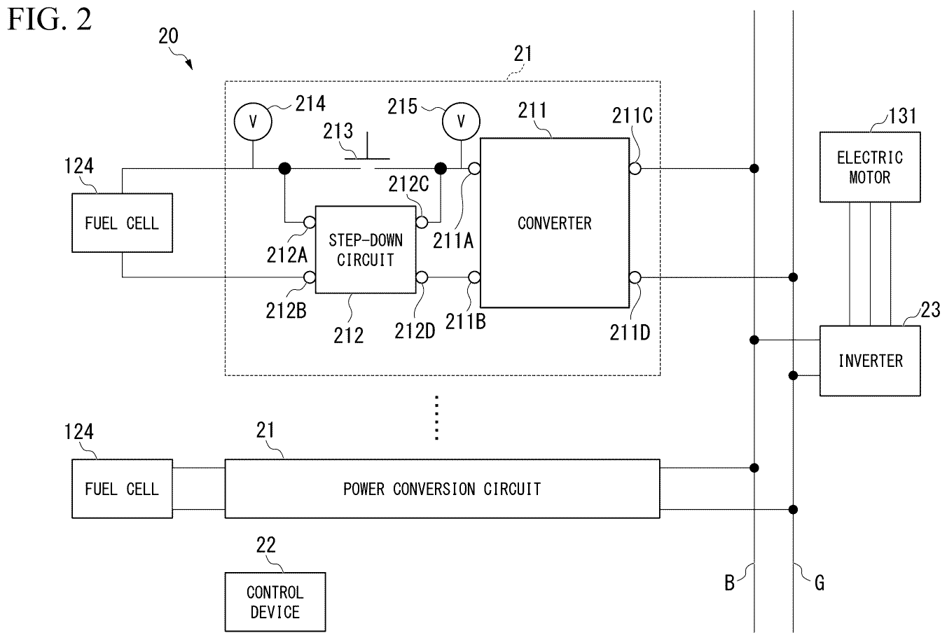

The power control system 20 converts the electric power generated by the plurality of fuel cells 124 into a predetermined voltage and supplies the converted power to the bus B. FIG. 2 is a schematic diagram showing the configuration of the power control system 20 according to the first embodiment. The power control system 20 includes power conversion circuits 21 corresponding to the plurality of fuel cells 124 and control devices 22 that control the power conversion circuits 21. In addition, an inverter 23 that generates AC power to be supplied to the electric motor 131 is provided on the bus B.

The power conversion circuit 21 includes a converter 211, a step-down circuit 212, a contactor 213, a first voltmeter 214, and a second voltmeter 215. The converter 211 converts the voltage supplied from the fuel cell 124 and supplies the converted voltage to the bus B. The converter 211 is a two-terminal pair circuit having a primary side terminal pair (i.e., an input terminal 211A and a primary side ground terminal 211B) and a secondary side terminal pair (i.e., an output terminal 211C and a secondary side ground terminal 211D). The output terminal 211C of the converter 211 is connected to the bus B, and the secondary side ground terminal 211D is connected to the ground G. That is, the electric power output by the converter 211 is supplied to the electric motor 131 through the bus B and the inverter 23. Therefore, it can be said that the converter 211 is connected to the electric motor 131.

The step-down circuit 212 steps down the electric power supplied from the fuel cell 124 and supplies the stepped-down power to the converter 211. The step-down circuit 212 is a two-terminal pair circuit having a primary side terminal pair (i.e., an input terminal 212A and a primary side ground terminal 212B) and a secondary side terminal pair (i.e., an output terminal 212C and a secondary side ground terminal 212D). The input terminal 212A of the step-down circuit 212 is connected to the positive electrode of the fuel cell 124, and the primary side ground terminal 212B is connected to the negative electrode of the fuel cell 124. The output terminal 212C of the step-down circuit 212 is connected to the input terminal 211A of the converter 211, and the secondary side ground terminal 212D is connected to the primary side ground terminal 211B of the converter 211.

The contactor 213 switches the connection and disconnection between the positive electrode of the fuel cell 124 and the input terminal 211A of the converter 211 under the control of the control device 22. The contactor 213 is provided in parallel with the chopper circuit 212 with respect to the fuel cell 124 and the converter 211.

The first voltmeter 214 measures the output voltage of the fuel cell 124.

The second voltmeter 215 measures the input voltage of the converter 211.

### <<Configuration of Step-Down Circuit 212>>

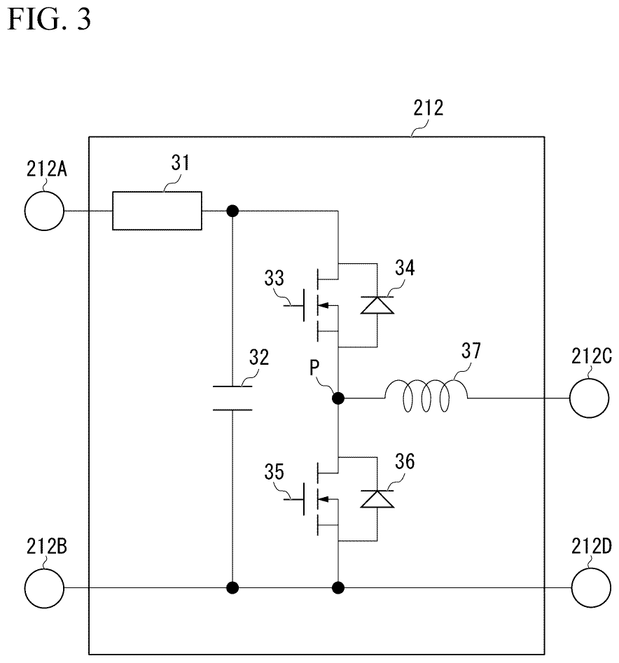

FIG. 3 is a circuit diagram showing the configuration of the step-down circuit 212 according to the first embodiment. The step-down circuit 212 is configured of, for example, a chopper circuit. The chopper circuit includes a resistor 31, a capacitor 32, a first switching element 33, a first diode 34, a second switching element 35, a second diode 36, and a reactor 37.

A first terminal of the resistor 31 is connected to the input terminal 212A. The resistor 31 is provided between the positive electrode of the fuel cell 124 and the input side of the converter 211.

The capacitor 32 is connected between a second terminal of the resistor 31 and the primary side ground terminal 212B. The capacitor 32 smooths the voltage output from the fuel cell 124.

The first switching element 33 is configured of, for example, an Insulated Gate Bipolar Transistor (IGBT) or a Metal Oxide Semiconductor Field Effect Transistor (MOSFET). The emitter of the first switching element 33 is connected to the collector of the second switching element 35, the collector of the first switching element 33 is connected to the second terminal of the resistor 31, and the base of the first switching element 33 is connected to the control device 22. Hereinafter, the point at which the emitter of the first switching element 33 and the collector of the second switching element 35 are connected is referred to as a connection point P. The first switching element 33 has a withstand voltage (for example, 1700 V) higher than the transient voltage during the startup of the fuel cell 124.

The first diode 34 is connected to the second switching element 35 in reverse parallel. Specifically, the anode of the first diode 34 is connected to the connection point P, and the cathode of the first diode 34 is connected to the second terminal of the resistor 31.

The second switching element 35 is configured of, for example, an IGBT or a MOSFET. The emitter of the second switching element 35 is connected to the secondary side ground terminal 212D, the collector of the second switching element 35 is connected to the connection point P, and the base of the second switching element 35 is connected to the control device 22. The second switching element 35 has a withstand voltage (for example, 1700 V) higher than the transient voltage during the startup of the fuel cell 124. The second switching element 35 switches conduction and non-conduction between an intermediate point between the resistor 31 and the converter 211, and the ground.

The second diode 36 is connected to the first switching element 33 in reverse parallel. Specifically, the anode of the second diode 36 is connected to the secondary side ground terminal 212D, and the cathode of the second diode 36 is connected to the connection point P.

The reactor 37 is an element that stores and releases DC power, and one terminal thereof is connected to the connection point P while the other terminal thereof is connected to the output terminal 212C.

The control device 22 generates a control signal for switching the first switching element 33 on and off and a control signal for switching the second switching element 35 on and off. The control signal generated by the control device 22 is supplied to the bases of the first switching element 33 and the second switching element 35.

### <<Configuration of Converter 211>>

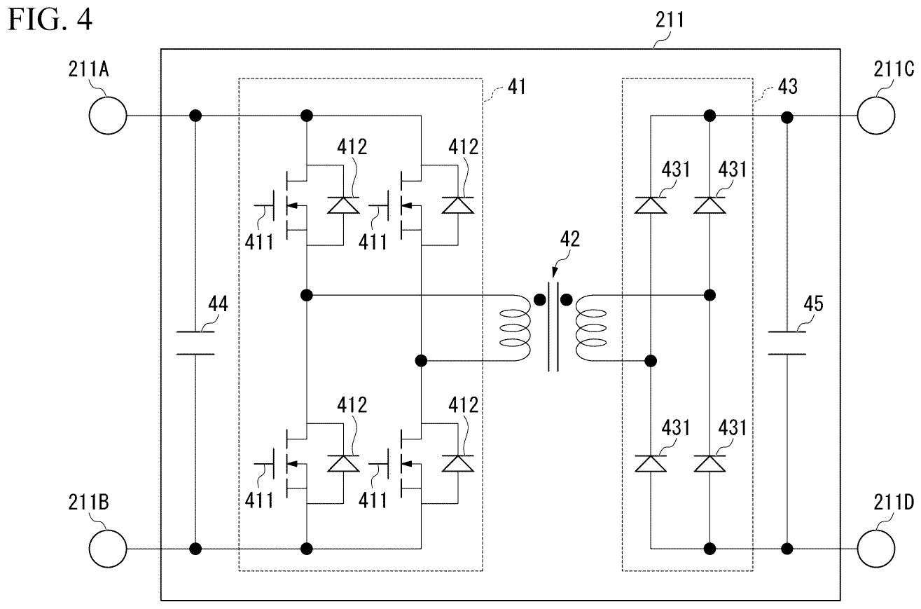

FIG. 4 is a circuit diagram showing the configuration of the converter 211 according to the first embodiment. It should be noted that the configuration of the converter 211 shown in FIG. 4 is merely an example and is not limited thereto. The converter 211 according to the first embodiment is an isolated-type switching regulator called full-bridge converter. The converter 211 includes an inverter 41, a rectifier circuit 43, a transformer 42, a first capacitor 44, and a second capacitor 45.

The inverter 41 includes four switching elements 411 and four diodes 412 provided in parallel with the switching elements 411. Each switching element 411 is configured of, for example, an IGBT or a MOSFET. Each switching element 411 is turned on and off by the control device 22 such that a desired voltage is applied to the primary side coil of the transformer 42. The voltage output from the inverter 41 is applied to the primary side coil of the transformer 42. Each switching element 411 has a withstand voltage equal to or higher than the rated voltage of the fuel cell 124. On the other hand, the withstand voltage of each switching element 411 may be less than the transient voltage during the startup of the fuel cell 124.

The transformer 42 converts the voltage applied to the primary side coil thereof into a voltage according to the winding ratio between the primary side coil and the secondary side coil thereof, and outputs the converted voltage from the secondary side coil. The voltage output from the secondary side coil is applied to the input side of the rectifier circuit 43.

The rectifier circuit 43 includes four diodes 431. The rectifier circuit 43 is a full-wave rectifier circuit using a diode bridge. The rectifier circuit 43 rectifies the AC voltage output from the secondary side coil of the transformer 42 to generate a DC voltage.

The first capacitor 44 is connected between the input terminal 211A and the primary side ground terminal 211B, and smooths the voltage to be output to the inverter 41.

The second capacitor 45 is connected between the output terminal 211C and the secondary side ground terminal 211D, and smooths the voltage output from the rectifier circuit 43.

### <<Control by Control Device 22>>

The control device 22 is realized by using a custom large scale integrated circuit (LSI) such as an application specific integrated circuit (ASIC) or a programmable logic device (PLD). Examples of the PLD include a programmable array logic (PAL), a generic array logic (GAL), a complex programmable logic device (CPLD), and a field programmable gate array (FPGA). It should be noted that, in another embodiment, the control device 22 may be a computer that includes a processor, a memory, an auxiliary storage device, and the like and functions by executing a program.

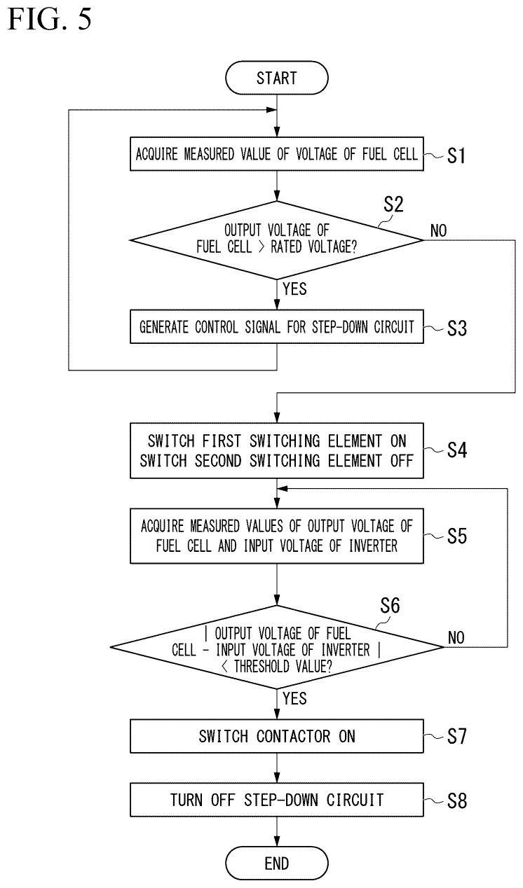

FIG. 5 is a flowchart showing the startup control of the fuel cell 124 according to the first embodiment. In a state in which the fuel cell 124 is stopped, the contactor 213 is in an off state. When the power supply from the fuel cell 124 starts, the control device 22 executes the startup control shown in FIG. 5. The control device 22 acquires the measured value of the first voltmeter 214 (step S1). That is, the control device 22 acquires the measured value of the voltage of the fuel cell 124. The control device 22 determines whether or not the measured value of the first voltmeter 214 exceeds the rated voltage (for example, 800 V) of the fuel cell 124 (step S2). In a case in which the measured value of the first voltmeter 214 exceeds the rated voltage of the fuel cell 124 (step S2: YES), the control device 22 generates a control signal for setting the output voltage of the step-down circuit 212 to the rated voltage of the fuel cell 124, and outputs the control signal to the first switching element 33 and the second switching element 35 (step S3). Then, the control device 22 returns the process to step S1 and monitors the state of the voltage. As a result, the voltage to be input to the converter 211 is the rated voltage of the fuel cell 124, and thus does not exceed the withstand voltage of the switching element 411 constituting the converter 211.

In a case in which the measured value of the first voltmeter 214 does not exceed the rated voltage of the fuel cell 124 (step S2: NO), the control device 22 generates a control signal for holding the first switching element 33 in the on state and holding the second switching element 35 in the off state, and outputs the control signal to the first switching element 33 and the second switching element 35 (step S4). As a result, the power generated by the fuel cell 124 is supplied to the converter 211 through the resistor 31 and the reactor 37.

Next, the control device 22 acquires the measured values of the first voltmeter 214 and the second voltmeter 215 (step S5). That is, the control device 22 acquires the measured value of the output voltage of the fuel cell 124 and the measured value of the input voltage of the inverter 41. The control device 22 determines whether or not the absolute value of the difference between the measured value of the first voltmeter 214 and the measured value of the second voltmeter 215 is equal to or less than a predetermined threshold value (step S6). That is, the control device 22 determines whether or not the measured value of the first voltmeter 214 and the measured value of the second voltmeter 215 are substantially equal. In a case in which the difference between the measured value of the first voltmeter 214 and the measured value of the second voltmeter 215 exceeds the predetermined threshold value (step S6: NO), the process returns to step S5, and the state of the voltage is monitored.

On the other hand, in a case in which the difference between the measured value of the first voltmeter 214 and the measured value of the second voltmeter 215 is equal to or less than the predetermined threshold value (step S6: YES), the control device 22 switches the contactor 213 from off to on (step S7). Then, the control device 22 turns off the supply of electric power to the step-down circuit 212 (step S8). As a result, after the fuel cell 124 reaches a steady operation state, the electricity generated by the fuel cell 124 is supplied to the converter 211 without passing through the step-down circuit 212. When the fuel cell 124 reaches the steady operation state, the output voltage of the fuel cell 124 is equal to or lower than the rated voltage thereof, and thus, even in a case in which the voltage of the fuel cell 124 is directly input to the converter 211, the voltage of the fuel cell 124 does not exceed the withstand voltage of the switching element 411 constituting the converter 211.

### <<Action and Effect>>

As described above, the power conversion circuit 21 according to the first embodiment includes the step-down circuit 212 provided between the fuel cell 124 and the converter 211, and the contactor provided in parallel with the step-down circuit 212, which switches conduction and insulation between the fuel cell 124 and the converter 211. With such a configuration, the control device 22 can suppress the voltage fluctuations during the startup of the fuel cell 124 by controlling the step-down circuit 212 and the contactor 213.

In addition, by configuring the power conversion circuit 21 as described above, it is not necessary to set the withstand voltage of the element constituting the converter 211 to be equal to or higher than the transient voltage during the startup of the fuel cell 124, and it is only necessary to set the withstand voltage of the element constituting the converter 211 to be equal to or higher than the rated voltage of the fuel cell 124. That is, it is not necessary to increase the withstand voltage of the converter 211 solely for the transient voltage during the startup of the fuel cell 124.

### Second Embodiment

In the first embodiment, the step-down circuit 212 is configured of the chopper circuit shown in FIG. 3. On the other hand, the step-down circuit 212 according to a second embodiment is configured of a pull-down circuit.

### <<Configuration of Step-Down Circuit 212>>

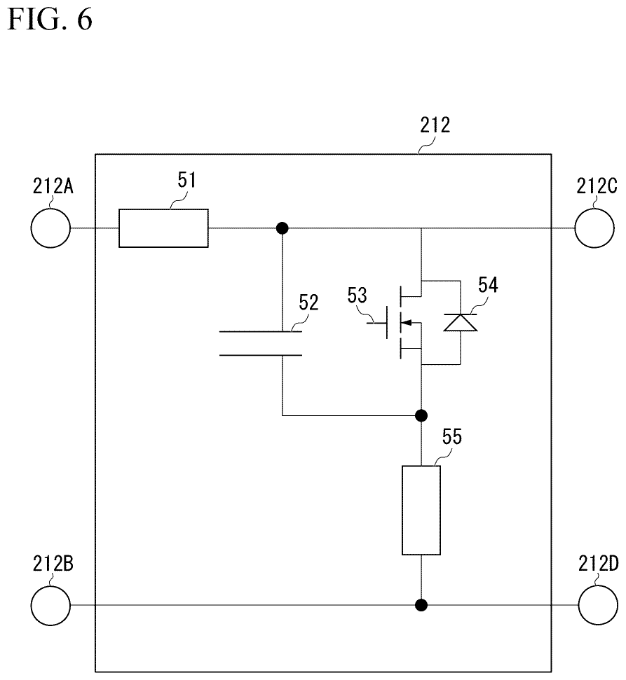

FIG. 6 is a circuit diagram showing the configuration of the step-down circuit 212 according to the second embodiment. The step-down circuit 212 according to the second embodiment includes a first resistor 51, a capacitor 52, a switching element 53, a diode 54, and a second resistor 55.

A first terminal of the first resistor 51 is connected to the input terminal 212A. A second terminal of the first resistor 51 is connected to the output terminal 212C. That is, the first resistor 51 is provided between the positive electrode of the fuel cell 124 and the input side of the converter 211.

The capacitor 52 is connected between the second terminal of the first resistor 51 and a first terminal of the second resistor 55.

The emitter of the switching element 53 is connected to the first terminal of the second resistor 55, the collector of the switching element 53 is connected to the second terminal of the first resistor 51, and the base of the switching element 53 is connected to the control device 22. The switching element 53 has a withstand voltage (for example, 1700 V) higher than the transient voltage during the startup of the fuel cell 124. That is, the switching element 53 switches between conduction and non-conduction between an intermediate point between the resistor 51 and the converter 211, and the ground.

The diode 54 is connected in reverse parallel to the switching element 53. Specifically, the anode of the diode 54 is connected to the first terminal of the second resistor 55, and the cathode of the diode 54 is connected to the second terminal of the first resistor 51.

The first terminal of the second resistor 55 is connected to a second terminal of the capacitor 52, the emitter of the switching element 53, and the anode of the diode 54. A second terminal of the second resistor 55 is connected to the primary side ground terminal 212B and the secondary side ground terminal 212D.

The control device 22 generates a control signal for switching the switching element 53 on and off. The control signal generated by the control device 22 is supplied to the base of the switching element 53.

In the configuration shown in FIG. 6, the step-down circuit 212 can also sequentially switch the switching element 53 on and off to step down the electric power supplied from the fuel cell 124 and supply the stepped-down power to the converter 211, similarly to the configuration shown in FIG. 3.

That is, in the flowchart shown in FIG. 5, in step S2, if the measured value of the first voltmeter 214 exceeds the rated voltage of the fuel cell 124, in step S3, the control device 22 generates a control signal to rapidly switch the switching element 53 on and off to set the output voltage of the step-down circuit 212 to the rated voltage of the fuel cell 124, and outputs the control signal to the switching element 53.

On the other hand, in a case in which, in step S2, the measured value of the first voltmeter 214 does not exceed the rated voltage of the fuel cell 124, in step S4, the control device 22 generates a control signal for holding the switching element 53 in the off state, and outputs the control signal to the switching element 53. As a result, the electric power generated by the fuel cell 124 is supplied to the converter 211 through the resistor 51.

Then, after the value of the output voltage of the fuel cell 124 and the value of the input voltage of the inverter 41 become substantially equal, in step S7, the control device 22 switches the contactor 213 from off to on, and in step S8, the control device 22 turns off the supply of electric power to the step-down circuit 212.

### <<Action and Effect>>

As described above, the power conversion circuit 21 according to the second embodiment can suppress the voltage fluctuations during the startup of the fuel cell 124 by controlling the step-down circuit 212 and the contactor 213, similarly to the first embodiment. In addition, the power conversion circuit 21 according to the second embodiment ensures that if the withstand voltage of the element constituting at least the converter 211 is equal to or higher than the rated voltage of the fuel cell 124, the voltage caused by the voltage fluctuations during the startup of the fuel cell 124 and applied to each element does not exceed the withstand voltage, similarly to the first embodiment.

### Another Embodiment

Although the embodiments have been described in detail with reference to the drawings, a specific configuration is not limited to the above-described configuration, and various design changes and the like can be made. That is, in another embodiment, the order of the above-described processes may be changed as appropriate. In addition, some processes may be executed in parallel.

### INDUSTRIAL APPLICABILITY

According to the above aspect, it is possible to suppress the voltage fluctuations during the startup of the fuel cell.

### REFERENCE SIGNS LIST

10: Transport vehicle
11: Dump body
12: Vehicle body
121: Platform
122: Cab
123: Control cabinet
124: Fuel cell
13: Travel device
20: Power control system
21: Power conversion circuit
211: Converter
211A: Input terminal
211B: Primary side ground terminal
211C: Output terminal
211D: Secondary side ground terminal
212: Step-down circuit
212A: Input terminal
212B: Primary side ground terminal
212C: Output terminal
212D: Secondary side ground terminal
213: Contactor
214: First voltmeter
215: Second voltmeter
22: Control device
31: Resistor
32: Capacitor
33: First switching element
34: First diode
35: Second switching element
36: Second diode
37: Reactor
41: Inverter
411: Switching element
412: Diode
42: Transformer
43: Rectifier circuit
431: Diode
44: First capacitor
45: Second capacitor
B: Bus
G: Ground
P: Connection point

1. A work vehicle, comprising:
a travel device;
an electric motor configured to drive the travel device;
a fuel cell that is a power source of the electric motor;
a converter connected to the electric motor;
a step-down circuit provided between the fuel cell and the converter;
a contactor provided in parallel with the step-down circuit and configured to switch conduction and insulation between the fuel cell and the converter; and
a control device configured to control the step-down circuit and the contactor.

2. The work vehicle according to claim 1, wherein
the control device insulates the contactor until a voltage of the fuel cell drops to a predetermined steady operation voltage, and conducts the contactor after the voltage of the fuel cell drops to the steady operation voltage.

3. The work vehicle according to claim 1, wherein
the step-down circuit includes
a resistor provided between a positive electrode of the fuel cell and an input side of the converter, and
a switching element configured to switch conduction and non-conduction between an intermediate point between the resistor and the converter and a ground.

4. The work vehicle according to claim 3, wherein
the control device
holds the switching element in an off state when a voltage of the fuel cell has dropped to a predetermined steady operation voltage, and
conducts the contactor when a difference between an input voltage of the converter and the voltage of the fuel cell is equal to or less than a predetermined value.

5. The work vehicle according to claim 3, wherein
the step-down circuit is a chopper circuit including
the resistor with a first terminal connected to the positive electrode of the fuel cell,
a reactor with a second terminal connected to the input side of the converter,
a first switching element that is the switching element connected between a second terminal of the resistor and a first terminal of the reactor,
a first diode connected between the second terminal of the resistor and the first terminal of the reactor in parallel with the first switching element,
a second switching element connected between the first terminal of the reactor and a negative electrode of the fuel cell, and
a second diode connected between the first terminal of the reactor and the negative electrode of the fuel cell in parallel with the second switching element.

6. The work vehicle according to claim 3, wherein
the step-down circuit is a pull-down circuit including
a first resistor that is the resistor with a first terminal connected to the positive electrode of the fuel cell and a second terminal connected to the input side of the converter,
a second resistor with a second terminal connected to the ground,
the switching element connected between the second terminal of the first resistor and a first terminal of the second resistor, and
a diode connected between the second terminal of the first resistor and the first terminal of the second resistor in parallel with the switching element.

7. The work vehicle according to claim 1, wherein
a withstand voltage of an element constituting the step-down circuit is greater than a transient voltage during startup of the fuel cell, and
a withstand voltage of an element constituting the converter is less than the transient voltage and greater than a steady operation voltage of the fuel cell.
